(19) United States
(12) Patent Application Publication
(10) Pub. No.: US 2026/0223235 A1
(43) Pub. Date: Jul. 30, 2026

(54) SMALL DATA TRANSMISSION

(71) Applicant: Nokia Technologies Oy, Espoo (FI)

(72) Inventors: Anna SILLANPAA, Espoo (FI); Samuli Heikki TURTINEN, Oulu (FI); Jussi-Pekka KOSKINEN, Oulu (FI); Philippe GODIN, Massy (FR)

(21) Appl. No.: 19/147,131

(22) PCT Filed: Jan. 31, 2024
(86) PCT No.: PCT/EP2024/052330

§ 371 Date: Jul. 10, 2025

(30) Foreign Application Priority Data
Apr. 3, 2023 (FI) 20235378

(51) Int. Cl. H04W 76/20; H04W 28/02

(52) U.S. Cl. CPC H04W 76/20; H04W 28/0278

(57) ABSTRACT

According to an example aspect of the present invention, there is provided an apparatus comprising at least one processing core and at least one memory storing instructions that, when executed by the at least one processing core, cause the apparatus, at least to determine that a small data transmission, SDT, procedure is ongoing with a user equipment which is in a radio resource control inactive state, and send assistance information to a control plane entity of a centralized unit of a base station.

### FIELD

The present disclosure relates to wireless communication.

### BACKGROUND

User equipments, UEs, of a cellular communication network may be in one of plural possible radio resource control, RRC, states, depending on how actively the UE is communicating with the network.

Switching from one RRC state to another involves some signalling in the network, in particular between base station and the UE. When the UE is in an idle state, it may request to be switched to a connected state by transmitting a request using a random access process, for example.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus, at least to determine that a small data transmission, SDT, procedure is ongoing with a user equipment which is in a radio resource control inactive state, and send assistance information to a control plane entity of a centralized unit of a base station.

According to a second aspect of the present disclosure, there is provided an apparatus comprising at least one processing core and at least one memory storing instructions that, when executed by the at least one processing core, cause the apparatus, at least to receive, in a control plane entity of a centralized unit for a base station comprising the centralized unit and a distributed unit, assistance information from a radio access node, for an ongoing small data transmission, SDT, procedure with a user equipment, UE, and determine, based at least in part on the received assistance information, whether to switch the radio resource control, RRC, state of the UE.

According to a third aspect of the present disclosure, there is provided a method, comprising determining that a small data transmission, SDT, procedure is ongoing with a user equipment which is in a radio resource control inactive state, and sending assistance information to a control plane entity of a centralized unit of a base station.

According to a fourth aspect of the present disclosure, there is provided a method, comprising receiving, in a control plane entity of a centralized unit for a base station comprising the centralized unit and a distributed unit, assistance information from a radio access node, for an ongoing small data transmission, SDT, procedure with a user equipment, UE, and determining, based at least in part on the received assistance information, whether to switch the radio resource control, RRC, state of the UE.

According to a fifth aspect of the present disclosure, there is provided an apparatus comprising means for determining that a small data transmission, SDT, procedure is ongoing with a user equipment which is in a radio resource control inactive state, and sending assistance information to a control plane entity of a centralized unit of a base station.

According to a sixth aspect of the present disclosure, there is provided an apparatus comprising means for receiving, in a control plane entity of a centralized unit for a base station comprising the centralized unit and a distributed unit, assistance information from a radio access node, for an ongoing small data transmission, SDT, procedure with a user equipment, UE, and determining, based at least in part on the received assistance information, whether to switch the radio resource control, RRC, state of the UE.

According to a seventh aspect of the present disclosure, there is provided a non-transitory computer readable medium having stored thereon a set of computer readable instructions that, when executed by at least one processor, cause an apparatus to at least determine that a small data transmission, SDT, procedure is ongoing with a user equipment which is in a radio resource control inactive state, and send assistance information to a control plane entity of a centralized unit of a base station.

According to an eighth aspect of the present disclosure, there is provided a non-transitory computer readable medium having stored thereon a set of computer readable instructions that, when executed by at least one processor, cause an apparatus to at least receive, in a control plane entity of a centralized unit for a base station comprising the centralized unit and a distributed unit, assistance information from a radio access node, for an ongoing small data transmission, SDT, procedure with a user equipment, UE, and determine, based at least in part on the received assistance information, whether to switch the radio resource control, RRC, state of the UE.

### BRIEF DESCRIPTION OF THE DRAWINGS

FIG. 1 illustrates an example system in accordance with at least some embodiments;

FIG. 2 illustrates a signalling example in accordance with at least some embodiments;

FIG. 3 illustrates a signalling example in accordance with at least some embodiments;

FIG. 4 illustrates a signalling example in accordance with at least some embodiments;

FIG. 5 illustrates an example apparatus capable of supporting at least some embodiments, and

FIG. 6 is a flow graph of a method in accordance with at least some embodiments.

### EMBODIMENTS

Disclosed herein are methods to facilitate data transmission in situations where a user equipment is in a radio resource control, RRC, inactive state and with an active data transmission context, such as a small data transmission, SDT. A small data transmission, or a small data transmission context, is an example of a data transmission context. To avoid loss of data when a data transmission context, such as an SDT, expires, the UE may be caused to switch to a RRC active state for transmitting data from at least one buffer. Further, or alternatively, in case a quantity of data in the buffer, or buffers, exceeds a data volume threshold, the UE may be caused to switch to the RRC active state to transmit the data. This could be the case if the quantity of data is large enough to warrant the RRC active state, rather than using SDT in the RRC inactive state.

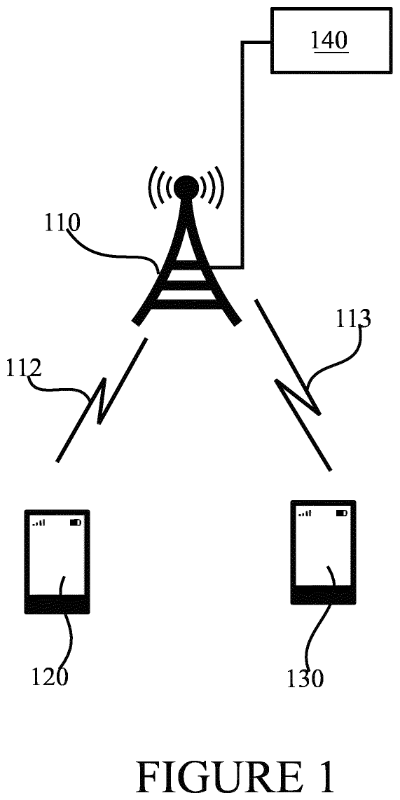

FIG. 1 illustrates an example system in accordance with at least some embodiments. A base station 110 controls at least one cell of a cellular communication system. Base station 110 is connected with node 140, which may comprise, for example, a core network node or a radio-access network controller. Examples of suitable core network nodes include an access and mobility management function, AMF, and a mobility management entity, MME. The core network node may be a physical and/or a logical node.

Base station 110 may be a unitary base station, or it may be a distributed base station. A distributed base station comprises a centralized unit, CU, and one or more distributed unit, DU. The DUs are furnished with radio parts and may handle radio link control, RLC, and medium access control, MAC, functions, while the CU may be configured to handle radio resource control, RRC, and packet data convergence protocol, PDCP, functions, for example. In a realistic physical network, the number of base stations may be in the hundreds, or even thousands, rather than the one illustrated in FIG. 1. The CU may further have logical node CU-UP for handling the user plane and logical node CU-CP for handling the control plane. The CU-UP and CU-CP may run on a same physical computing substrate, for example, or on separate computing substrates. The CU-CP may be configured to run the RRC and a control plane part of the PDCP protocol, while the CU-UP may be configured to run the user-plane part of the PDCP protocol, and service data adaptation protocols, SDAP, for example. An E1 interface may connect the CP-CP to the CP-UP while an F1-C interface may connect the CP-CP to the DU(s) in a network based on 3^{rd} generation partnership project, 3GPP, standards.

UEs 120, 130 are in at least intermittent contact with base station 110 via radio links 112 and 113, respectively. For example, UE 120 may be in an RRC_Inactive state, wherein base station 110 does not provide the UE with reserved radio interface resources, and both UE 120 and base station 110 store a UE context of UE 120, such as, for example, an access stratum, AS, context, of UE 120. Storing the UE context makes a transition to RRC_Connected state faster. In active RRC states, such as RRC_Connected, the UE is provided with reserved radio interface resources. In the RRC_Inactive state, an RRC connection between the UE and the base station is suspended, while in the RRC_Idle state there is no RRC connection between base station and UE, and no UE context is stored for the UE in the base station. In the RRC_Idle state, the UE is not registered in a particular cell and has no reserved radio interface resources. UE 130 may be in RRC_Connected state, for example in case it is in an ongoing data transfer session with a correspondent node via base station 110.

UE 120, in the RRC_Inactive state, may have an ongoing data transmission context, such as a small data transmission, SDT. The SDT will hereafter be used as an example of the data transmission context. An SDT is a framework useful for transferring small quantities of e.g. mobile-originated user-plane data between the UE and the network without requiring switching the UE to an RRC active state, such a RRC_Connected. The data transmission of the SDT may take place using, for example, random access and/or uplink configured grant procedures while maintaining the UE in RRC_Inactive state. Maintaining the UE in the RRC_Inactive state is efficient in terms of signalling, since switching to RRC_Connected state and then back to RRC_Inactive would involve a lot of signalling with the base station.

An ongoing SDT may end by the UE being transitioned to the RRC_Idle state after the purpose of the SDT has been accomplished, for example. The UE may also be left in RRC_Inactive following expiry of an SDT. Further, the SDT may be ended in case an SDT timer expires. Responsive to the SDT timer expiry, the UE may be switched to the RRC_Idle state.

The SDT, or more generally data transmission context, however presents a few challenges as well. For sending larger amounts of data, the RRC_Inactive state with SDT uplink and/or downlink transmission is not optimized from a radio capacity perspective since channel quality information, CQI, beam, sounding reference signal, SRS, and other reporting typical of the RRC_Connected state is not used between the UE and base station in the RRC_Inactive state. Further, in RRC_Inactive state UE energy use is not optimal since the UE may need to continuously listen to physical downlink control channel, PDCCH, for possible downlink SDT transmissions during the SDT procedure. As a result, the base station cannot optimally estimate the radio link quality for the UE, which negatively impacts the modulation and coding used. Thus, for the data transmission, in SDT a lower modulation and coding scheme and more physical radio resource blocks may be used compared to communicating in the RRC_Connected mode, to avoid a large amount of retransmissions in SDT. In addition, scheduling in RRC_Connected mode is more efficient than in SDT for larger quantities of data because of better link adaptation procedures, such as channel state information, CSI, reporting, are supported.

Thus, if a relatively large quantity of data is to be transmitted using SDT, it would be more useful to conduct this transmission in RRC_Connected state, even considering the signalling needed to switch the UE to RRC_Connected state.

Further, in case an SDT expires with data still to be transmitted in at least one uplink or downlink buffer, this data may be discarded as the UE switches to RRC_Idle state. There may be data in an uplink buffer in the UE, and/or in a downlink buffer in the base station, for example. An SDT may expire when an SDT timer expires, for example. Such a timer may be initialized to an initial value when an SDT is begun.

To overcome such challenges, procedures are herein disclosed which switch the UE from the RRC_Inactive state to an active state, such as RRC_Connected state, responsive to one or more determination. Firstly, it may be determined that, during an SDT procedure, a quantity of data to be transmitted in the SDT procedure exceeds a data volume threshold. The data volume threshold may be expressed in terms of a quantity of data, such as in kilobytes or megabytes, or as a number of bits, for example. Responsive to there being more than the data volume threshold quantity of data in a transmit buffer in the UE and/or base station while the UE is in SDT, a switch of the UE to the RRC active state may be triggered, as will be discussed in more detail herein below. Secondly, alternatively or in addition to the determination based on the quantity of data to be transmitted, it may be determined that, during an SDT procedure, a length of time remaining in a duration of the SDT procedure is less than a threshold duration and there remains data to be transmitted in the SDT procedure, in the uplink or downlink.

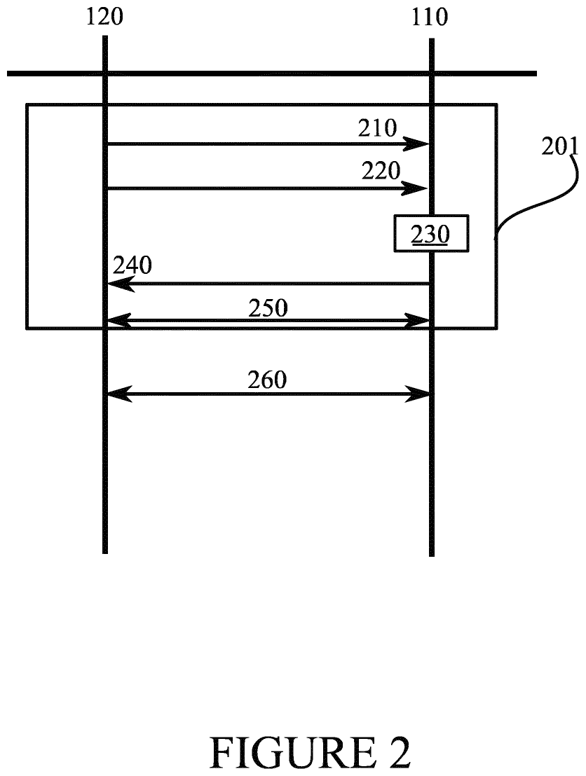

FIG. 2 illustrates a signalling example in accordance with at least some embodiments. On the vertical axes are disposed UE 120 and base station 110, with like numbering denoting like structure as in FIG. 1.

Phase 201 represents an ongoing SDT between UE 120 and base station 110, with the UE in RRC_Inactive state. The SDT may be a mobile-originated or a mobile-terminated SDT. During this SDT context, the UE provides data quantities 210 and 220 to base station 110. However, in phase 230 the base station determines that UE 110 should be switched to RRC_Connected state, and phase 240 represents a triggering of the RRC state switch from RRC_Inactive to RRC_Connected state. A signalling process relating to switching of UE 120 from RRC_Inactive to RRC_Connected is schematically represented as phase 250, after which the UE is in RRC_Connected state and SDT 201 is ended. In phase 260, communication in RRC_Connected state takes place between the UE and the base station. The determination of phase 230 may be based on a quantity of data to be transmitted during the SDT procedure, or an SDT timer approaching expiry with data still remaining to be transmitted, for example.

In connection with the end of SDT 201, data in buffers relating to the SDT transmission is maintained, and not discarded. Such data may be communicated in phase 260. In case the base station is distributed, the DU or CU-UP may determine, in phase 230, that RRC_Connected state is more appropriate. The DU or CU-UP may then inform the CU-CP of this, and the CU-CP may trigger the message of phase 240. In one variant of the embodiments of FIG. 2, a DU informs CU-CP of the UL data volume every time it receives a buffer status report, BSR, from UE 120. Alternatively, the CU-CP may perform the determination of phase 230. In general, the DU and/or the CU-UP may be configured to provide the CU-CP with assistance information based on which the CU-CP may decide, in phase 230, that the RRC_Connected state is preferred. The assistance information may be e.g. at least one buffer status report (representing UL data volume), downlink data volume, or an indication of data volume (UL and/or DL) exceeding the data volume threshold or an indication that SDT timer is approaching expiry with data still remaining to be transmitted. The message of phase 240 is a message concerning switching the user equipment to a radio resource control active state such as RRC connected state.

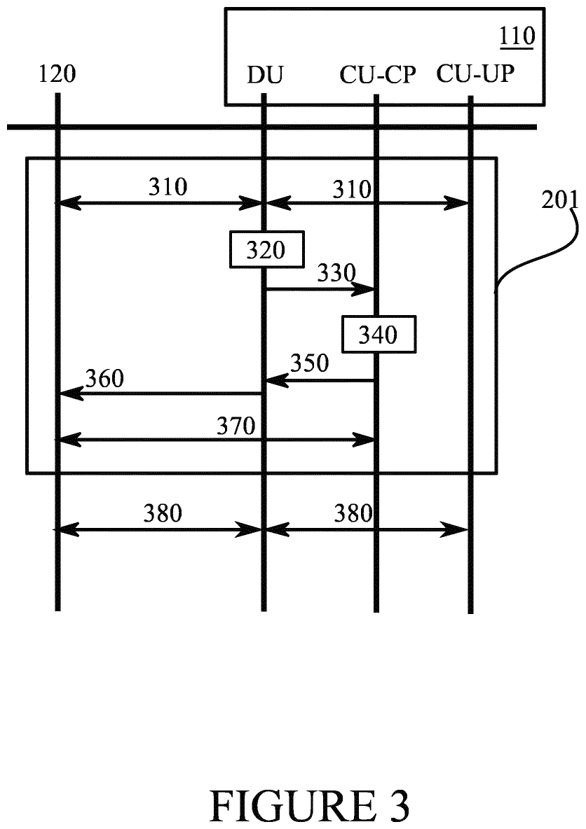

FIG. 3 illustrates a signalling example in accordance with at least some embodiments. On the vertical axes are disposed UE 120 on the left and base station 110 on the right, with like numbering denoting like structure as in FIG. 2. The base station of FIG. 3 is distributed, comprising the DU, the CU-CP and the CU-UP, as described herein above.

An active SDT 201 is present, as was the case in FIG. 2. Initially, phase 310, SDT data transfer takes place in the SDT context 201, which was described in connection with FIG. 2. In phase 320, the DU determines that a quantity of data to be transmitted in the SDT exceeds a data volume threshold, and/or that a length of time remaining in a duration of the SDT is less than a threshold duration while there remains data to be transmitted using the SDT. In other words, the DU may perform a quantity of data based determination, or a determination based on a timer and presence of data to be transmitted. Phase 320 may comprise determining to send assistance information to the CU-CP as a response to the quantity of data based determination, or the determination based on the timer and presence of data to be transmitted. A determination that a quantity of data to be transmitted over the SDT exceeds a data volume threshold may be based, at least in part, on buffer status reporting, BSR, from the UE, for example, or on DL data volume buffer(s). The quantity of data based determination may be based on an accumulated data threshold across all logical channel groups, LCGs, in a buffer status report, BSR, or based on separate LCG specific data volume threshold(s), that is, if buffer status indicated for a specific LCG exceeds a threshold level, the DU may determine the quantity of data exceeds at least one data volume threshold.

The DU may be provided an indication of the data volume threshold or the threshold duration from the CU-CP, for example. The CU-CP may use an F1AP UE Context Setup Request or UE Context Modification Request message to indicate the data volume threshold or threshold duration to the DU, for example. Alternatively, the data volume threshold or the threshold duration may be configured in the DU from an operation and maintenance system. Yet further, the data volume threshold or the threshold duration may be a constant threshold, or thresholds, specified at manufacture of the DU. Further, an initial value of the SDT timer may be indicated to the DU from the CU-CP, an operation and maintenance system or as a constant specified at manufacture, for example as discussed above for the data volume threshold and threshold duration. The SDT timer may be referred to as an SDT maximum duration, SMD, timer.

In phase 330, the DU signals to the CU-CP, indicating a result of the determination of phase 320 and/or that a switch of UE 120 to an active RRC state, such as RRC_Connected, would be appropriate. The signal of phase 330 may indicate that the SMD (SDT Maximum Duration) timer is close to expiry and data remains to be transmitted over the SDT procedure, or alternatively the message of phase 330 may indicate that a quantity of data to be transmitted over SDT 201 exceeds the data volume threshold. The message of phase 330 may be a F1AP UE Context Modification Required message, for example. In case the determination is based on the quantity of data, the message of phase 330 may inform CU-CP that the sum of all the UL data reported in the BSR exceeds the data volume threshold, or it can inform that the UL data of one particular LCG exceeds the data volume threshold as reported by the UE.

In phase 340, responsive to phase 330, the CU-CP determines to switch UE 120 to RRC_Connected state, and a signal triggering this change is sent to the DU in phase 350. The message of phase 350 may be a UE Context Modification Confirm message including an RRC Resume, for example. The DU, which is the part of base station 110 communicating wirelessly with UE 120, reacts by transferring the RRC Resume message to the UE in phase 360, which leads to an RRC process 370 which switches UE 120 to the RRC_Connected state and ends SDT 201. The messages of phases 330, 350 and 360 are messages concerning switching the user equipment to a radio resource control active state. The message of phase 330 comprises assistance information. The DU may be configured to generate the assistance information.

Following the end of SDT 201, UE 120 and base station 110 may communicate, phase 380, in RRC_Connected mode. For example, data which was in at least one SDT transmit buffer in phase 320 may be communicated in phase 380. In case the determination of phase 320 was based on an SDT timer, this provides the benefit that this data is successfully communicated instead of being discarded at expiry of the SDT timer. Alternatively, if the determination of phase 320 was based on the quantity of data to be transmitted, a benefit may be obtained in that the transmission of the data is achieved using less energy, as described herein above.

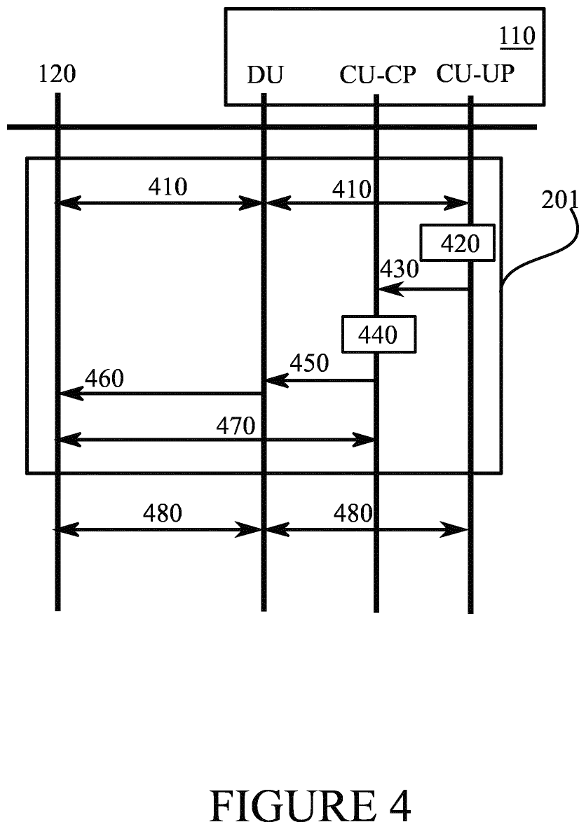

FIG. 4 illustrates signalling in accordance with at least some embodiments. On the vertical axes are disposed UE 120 on the left and base station 110 on the right, with like numbering denoting like structure as in FIG. 2 and FIG. 3. The base station of FIG. 4 is distributed, comprising the DU, the CU-CP and the CU-UP, as described herein above.

An active SDT 201 is present, as was the case in FIGS. 2 and 3. Initially, phase 410, SDT data transfer takes place in the SDT context 201. In phase 420, the CU-UP determines that a quantity of data to be transmitted over the SDT procedure exceeds a data volume threshold, and/or that a length of time remaining in a duration of the SDT procedure is less than a threshold duration while there remains data to be transmitted using the SDT. In other words, the CU-UP may perform a quantity of data based determination, or a determination based on a timer and presence of data to be transmitted. A determination that a quantity of data to be transmitted over the SDT exceeds a data volume threshold may be based on, for example, on a status of a data buffer in the CU-UP. The CU-UP buffer status may relate to downlink data. Phase 420 may comprise determining to send assistance information to the CU-CP as a response to the quantity of data based determination, or to the determination based on the timer and presence of data to be transmitted. The CU-UP may be configured to generate the assistance information. The data volume threshold may relate to a sum of UL and DL data in all buffers of SDT bearers, or it may relate separately to UL and DL data of the buffer of one particular SDT bearer, such that if at least one of UL and DL data buffer status to be transmitted exceeds the data volume threshold, the CU-UP determines that the quantity of data to be transmitted over the SDT procedure exceeds the threshold.

The CU-UP may be provided an indication of the data volume threshold or the threshold duration from the CU-CP, for example. The CU-CP may use an E1AP Bearer Context Setup Request or E1AP Bearer Context Modification Request message, for example, to indicate the data volume threshold or threshold duration to the CP-UP. Alternatively, the data volume threshold or the threshold duration may be configured in the CU-UP from an operation and maintenance system. Yet further, the data volume threshold or the threshold duration may be a constant threshold, or thresholds, specified at manufacture of the CU-UP. Further, an initial value of the SDT timer may be indicated to the CU-UP from the CU-CP, an operation and maintenance system or as a constant specified at manufacture, for example, as discussed above for the data volume threshold and threshold duration. The SDT timer may be referred to as an SDT maximum duration, SMD, timer.

In phase 430, the CU-UP signals to the CU-CP, indicating a result of the determination of phase 420 and/or that a switch of UE 120 to an active RRC state, such as RRC_Connected, would be appropriate. The signal of phase 430 may indicate that the SMD timer is close to expiry and data remains to be transmitted over the SDT, or alternatively the message of phase 430 may indicate that a quantity of data to be transmitted over SDT 201 exceeds the data volume threshold. The message of phase 430 may be a E1AP DL Data Notification message, for example.

In phase 440, responsive to phase 430, the CU-CP determines to switch UE 120 to RRC_Connected phase. Subsequent phases 450-480 correspond to phases 350-380 of FIG. 3. The messages of phases 430, 450 and 460 are messages concerning switching the user equipment to a radio resource control active state. The message of phase 430 comprises assistance information.

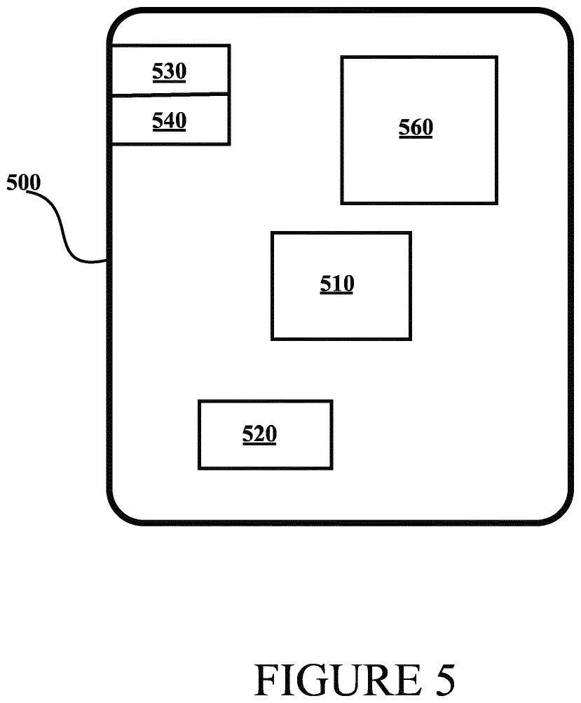

FIG. 5 illustrates an example apparatus capable of supporting at least some embodiments. Illustrated is device 500, which may comprise, for example, a base station, a DU or a CU. Comprised in device 500 is processor 510, which may comprise, for example, a single- or multi-core processor wherein a single-core processor comprises one processing core and a multi-core processor comprises more than one processing core. Processor 510 may comprise, in general, a control device. Processor 510 may comprise more than one processor. When processor 510 comprises more than one processor, device 500 may be a distributed device wherein processing of tasks takes place in more than one physical unit. Processor 510 may be a control device. A processing core may comprise, for example, a Cortex-A8 processing core manufactured by ARM Holdings or a Zen processing core designed by Advanced Micro Devices Corporation. Processor 510 may comprise at least one Qualcomm Snapdragon and/or Intel Atom processor. Processor 510 may comprise at least one application-specific integrated circuit, ASIC. Processor 510 may comprise at least one field-programmable gate array, FPGA. Processor 510 may be means for performing method steps in device 500, such as determining, triggering, performing, receiving, transmitting and communicating. Processor 510 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a base station, DU or CU, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 500 may comprise memory 520. Memory 520 may comprise random-access memory and/or permanent memory. Memory 520 may comprise at least one RAM chip. Memory 520 may comprise solid-state, magnetic, optical and/or holographic memory, for example. Memory 520 may be at least in part accessible to processor 510. Memory 520 may be at least in part comprised in processor 510. Memory 520 may be means for storing information. Memory 520 may comprise computer instructions that processor 510 is configured to execute. When computer instructions configured to cause processor 510 to perform certain actions are stored in memory 520, and device 500 overall is configured to run under the direction of processor 510 using computer instructions from memory 520, processor 510 and/or its at least one processing core may be considered to be configured to perform said certain actions. Memory 520 may be at least in part comprised in processor 510. Memory 520 may be at least in part external to device 500 but accessible to device 500. Memory 520 may be non-transitory. The term “non-transitory”, as used herein, is a limitation of the medium itself (that is, tangible, not a signal) as opposed to a limitation on data storage persistency (for example, RAM vs. ROM).

Device 500 may comprise a transmitter 530. Device 500 may comprise a receiver 540. Transmitter 530 and receiver 540 may be configured to transmit and receive, respectively, information in accordance with at least one cellular or non-cellular standard. Transmitter 530 may comprise more than one transmitter. Receiver 540 may comprise more than one receiver. Transmitter 530 and/or receiver 540 may be configured to operate in accordance with global system for mobile communication, GSM, wideband code division multiple access, WCDMA, 5G, 6G, long term evolution, LTE, IS-95, wireless local area network, WLAN, Ethernet and/or worldwide interoperability for microwave access, WiMAX, standards, for example.

Device 500 may comprise user interface, UI, 560. UI 560 may comprise at least one of a display, a keyboard, a touchscreen, a vibrator arranged to signal to a user by causing device 500 to vibrate, a speaker and a microphone. A user may be able to operate device 500 via UI 560, for example to configure communication context parameters or thresholds.

Processor 510 may be furnished with a transmitter arranged to output information from processor 510, via electrical leads internal to device 500, to other devices comprised in device 500. Such a transmitter may comprise a serial bus transmitter arranged to, for example, output information via at least one electrical lead to memory 520 for storage therein. Alternatively to a serial bus, the transmitter may comprise a parallel bus transmitter. Likewise processor 510 may comprise a receiver arranged to receive information in processor 510, via electrical leads internal to device 500, from other devices comprised in device 500. Such a receiver may comprise a serial bus receiver arranged to, for example, receive information via at least one electrical lead from receiver 540 for processing in processor 510. Alternatively to a serial bus, the receiver may comprise a parallel bus receiver.

Device 500 may comprise further devices not illustrated in FIG. 5. In some embodiments, device 500 lacks at least one device described above.

Processor 510, memory 520, transmitter 530, receiver 540, and/or UI 560 may be interconnected by electrical leads internal to device 500 in a multitude of different ways. For example, each of the aforementioned devices may be separately connected to a master bus internal to device 500, to allow for the devices to exchange information. However, as the skilled person will appreciate, this is only one example and depending on the embodiment various ways of interconnecting at least two of the aforementioned devices may be selected without departing from the scope of the present invention.

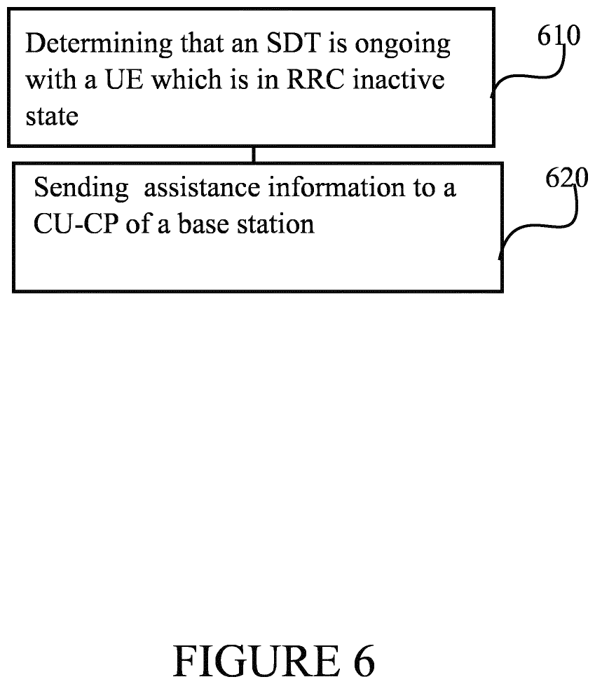

FIG. 6 is a flow graph of a method in accordance with at least some embodiments. The phases of the illustrated method may be performed in base station 110, for example, or in a control device configured to control the functioning thereof, when installed therein.

Phase 610 comprises determining that a small data transmission, SDT, procedure is ongoing with a user equipment which is in a radio resource control inactive state. Phase 620 comprises sending assistance information to a control plane entity of a centralized unit of a base station. As discussed herein above, determining of to send the assistance information may be based on a quantity of data to be transmitted exceeds a data volume threshold related to the small data transmission procedure. Alternatively or in addition, the determining to send the assistance information may be based on a length of time remaining in a duration of the SDT procedure being less than a threshold duration and there remaining data to be transmitted using the SDT. Alternatively to specifically an SDT, more generally a data transmission context may be employed. The sending of a message concerning switching the user equipment to a radio resource control active state may be accomplished by a base station, by a DU, or by a CU-CP. Examples of such messages have been described herein above in connection with FIGS. 2, 3 and 4.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in managing wireless communication.

### ACRONYMS LIST

3GPP 3^{rd} generation partnership project
5G fifth generation
6G sixth generation
AMF access and mobility management function
CU centralized unit
CU-CP centralized unit control plane node
CU-UP centralized unit user plane node
CQI channel quality information
DL downlink
LTE long term evolution
MAC medium access control
MME mobility management entity
PDCCH physical downlink control channel
PDCP packet data convergence protocol
RLC radio link control
RRC radio resource control
SDAP service data adaptation protocols
SDT small data transmission
SMD SDT maximum duration
SRS sounding reference signal
UE user equipment
UL uplink
WCDMA wideband code division multiple access
WiMAX worldwide interoperability for microwave access
WLAN wireless local area network

REFERENCE SIGNS LIST

| | |
|---|---|
| 110 | base station |
| 120, 130 | UE |
| 112, 113 | radio links |
| 140 | core network node |
| 201 | small data transmission |
| 210 - 260 | stages of the signalling process of FIG. 2 |
| 310 - 380 | stages of the signalling process of FIG. 3 |
| 410 - 480 | stages of the signalling process of FIG. 4 |
| 500 - 560 | structure of the device of FIG. 5 |
| 610 - 630 | phases of the method of FIG. 6 |

### Technical Clauses

Clause 1. A method, comprising:
determine, in an apparatus, that a small data transmission, SDT, procedure is ongoing with a user equipment which is in a radio resource control inactive state, and
send assistance information to a control plane entity of a centralized unit of a base station.

Clause 2. The method according to Clause 1, wherein the method comprises performing the determination to send the assistance information based on at least one of:
a determination that a quantity of data to be transmitted in the SDT procedure exceeds at least one data volume threshold related to the small data transmission, and
a determination that a timer associated to the ongoing SDT procedure duration has less than a threshold duration remaining while data remains to be sent.

Clause 3. The method according to Clause 1 or 2, wherein the assistance information comprises at least one of:
an indication of data volume to be transmitted,
a UE buffer status report,
an indication that the data volume to be transmitted in the SDT procedure has exceeded the at least one data volume threshold,
an indication of time or duration related to the SDT procedure,
an indication of that the timer has less than a threshold duration remaining,
a recommendation or preference of switching a radio resource control state of the UE,
a recommendation or preference of the radio resource control state of the UE.

Clause 4. The method according to any of Clauses 2-3, wherein the method comprises receiving the at least one data volume threshold, the threshold duration or an initial value for the timer from an operation and maintenance system or from signalling received in the apparatus from the control plane entity of the centralized unit.

Clause 5. The method according to Clause 4, wherein the signalling from the control plane entity of the centralized unit relates to a context for the user equipment stored or to be created in the apparatus.

Clause 6. The method according to any preceding Clause, wherein the apparatus is a distributed unit for a base station comprising the distributed unit and the centralized unit.

Clause 7. The method according to Clause 6 as dependent on Clause 2, wherein the method comprises performing, by the distributed unit, the determining that the quantity of data exceeds the at least one data volume threshold based on at least one buffer status report associated with the SDT.

Clause 8. The method according to Clause 6, wherein the at least one data volume threshold is specific to at least one of the UE and a logical channel group.

Clause 9. The method according to any preceding Clause, wherein the method comprises sending the assistance information to the control plane entity of the centralized unit in an F1AP UE Context Modification Required message.

Clause 10. The method according to any of Clauses 1-5, wherein the apparatus is a user plane entity of the centralized unit.

Clause 11. The method according to Clause 10, wherein the method comprises receiving, from the control plane entity of the centralized unit, signalling which relates to a context of the user equipment stored or to be created in the apparatus, the signalling comprising an E1AP Bearer Context Setup/Modification Request message.

Clause 12. The method according to any of Clauses 11-12 wherein the method comprises sending the assistance information to the control plane entity of the centralized unit in an E1AP DL Data Notification message.

Clause 13. A method, comprising:
receiving, in a control plane entity of a centralized unit for a base station comprising the centralized unit and a distributed unit, assistance information from a radio access node, for an ongoing small data transmission, SDT, procedure with a user equipment, UE, and
determining, based at least in part on the received assistance information, whether to switch the radio resource control, RRC, state of the UE.

Clause 14. The method according to Clause 13, wherein the method comprises:
determining, based on the assistance information, to switch the UE to RRC connected state, and
sending an RRC message to switch the UE to the RRC connected state.

Clause 15. The method according to Clause 13 or 14 wherein the assistance information comprises at least one of:
an indication of data volume,
a UE buffer status report,
an indication that a data volume has exceeded at least one data volume threshold,
an indication of a value of a timer related to the SDT procedure, an indication that the timer has less than a threshold duration remaining,
a recommendation or preference of switching the radio resource control state of the UE,
a recommendation or preference of the radio resource control state of the UE.

Clause 16. The method according to any of Clauses 13 to 15, further comprising:
signalling to the radio access node at least one of at least one data volume threshold value or an initial SDT timer value,
receiving the assistance information from the radio access node as a response to the signalling.

Clause 17. The method according to Clause 13 to 16 wherein the radio access node is a distributed unit of the base station, or comprised in the distributed unit of the base station.

Clause 18. The method according to Clause 17, wherein the method comprises receiving the assistance information in an F1AP UE Context Modification Required message or an E1AP DL Data Notification message.

Clause 19. The method according to any of clauses 13 to 16, wherein the radio access node is a user plane entity of the central unit of the base station.

Clause 20. The method according to clause 15 as dependent on clause 14, wherein the determining whether to switch the RRC state of the UE is based on determining that a quantity of data to be transmitted, determined based on the buffer status report, exceeds the at least one data volume threshold.

Clause 21. The method according to Clause 16, wherein the method comprises performing the signalling of the at least one of the at least one data volume threshold or the initial SDT timer value in an F1AP UE Context Setup Request message or an F1AP UE Context Modification Request message or an E1AP Bearer Context Setup Request message or an E1AP Bearer Context Modification Request message.

Clause A1: An apparatus comprising at least one processing core and at least one memory storing instructions that, when executed by the at least one processing core, cause the apparatus, the apparatus comprising a base station apparatus, at least to:
determine that a small data transmission, SDT, is ongoing with a user equipment which is in a radio resource control inactive state, and
send a message concerning switching the user equipment to a radio resource control active state.

Clause A2: An apparatus according to Clause A1, further configured to:
determine that a quantity of data to be transmitted exceeds a data volume threshold related to the small data transmission, and
perform the sending of the message concerning switching the user equipment to the radio resource control active state based on the determining that the data volume threshold is exceeded.

Clause A3: An apparatus according to Clause A1, further configured to:
determine that a length of time remaining in a timer of the small data transmission is less than a threshold duration while there remains data to be transmitted using the small data transmission, and
perform the sending of the message concerning switching the user equipment to the radio resource control active state based on the determining that the length of time remaining in the timer of the small data transmission is less than the threshold duration and there remains data to be transmitted using the small data transmission.

Clause A4: A method, comprising:
determining that a small data transmission, SDT, is ongoing with a user equipment which is in a radio resource control inactive state, and
sending a message concerning switching the user equipment to a radio resource control active state

Clause A5: An apparatus comprising means for:
determining that a small data transmission, SDT, is ongoing with a user equipment which is in a radio resource control inactive state, and sending a message concerning switching the user equipment to a radio resource control active state.

Clause A6: A non-transitory computer readable medium having stored thereon a set of computer readable instructions that, when executed by at least one processor, cause an apparatus to at least:
determine that a small data transmission, SDT, is ongoing with a user equipment which is in a radio resource control inactive state, and
send a message concerning switching the user equipment to a radio resource control active state.

1. An apparatus comprising at least one processing core and at least one memory storing instructions that, when executed by the at least one processing core, cause the apparatus, at least to:
determine that a small data transmission; (SDT), procedure is ongoing with a user equipment which is in a radio resource control inactive state, and
send assistance information to a control plane entity of a centralized unit of a base station.

2. The apparatus according to claim 1, wherein the apparatus is further caused to send the assistance information based on at least one of:
a determination that a quantity of data to be transmitted in the SDT procedure exceeds at least one data volume threshold related to the small data transmission, and
a determination that a timer associated to the ongoing SDT procedure duration has less than a threshold duration remaining while data remains to be sent.

3. The apparatus according to claim 1, wherein the assistance information comprises at least one of:
an indication of data volume to be transmitted,
a UE buffer status report,
an indication that the data volume to be transmitted in the SDT procedure has exceeded the at least one data volume threshold,
an indication of time or duration related to the SDT procedure,
an indication of that the timer has less than a threshold duration remaining,
a recommendation or preference of switching a radio resource control state of the UE,
a recommendation or preference of the radio resource control state of the UE.

4. The apparatus according to claim 2, wherein the apparatus is further caused to receive the at least one data volume threshold, the threshold duration or an initial value for the timer from an operation and maintenance system or from the control plane entity of the centralized unit.

5. The apparatus according to claim 4, wherein the signalling from the control plane entity of the centralized unit relates to a context for the user equipment stored or to be created in the apparatus.

6. The apparatus according to claim 1, wherein the apparatus is a distributed unit for a base station, wherein the base station comprises the distributed unit and the centralized unit.

7. The apparatus according to claim 1, wherein the distributed unit is further caused to perform the determining that the quantity of data to be transmitted in the SDT procedure exceeds at least one data volume threshold based on at least one buffer status report associated with the SDT.

8. The apparatus according to claim 7, wherein the at least one data volume threshold is specific to at least one of the UE or a logical channel group.

9. The apparatus according to claim 6, wherein the apparatus is further caused to send the assistance information to the control plane entity of the centralized unit in an F1AP UE Context Modification Required message.

10. The apparatus according to claim 1, wherein the apparatus is a user plane entity of the centralized unit.

11. The apparatus according to claim 10, wherein the apparatus is further caused to receive, from the control plane entity of the centralized unit, signalling which relates to a context of the user equipment stored or to be created in the apparatus, the signalling comprising an E1AP Bearer Context Setup/Modification Request message.

12. The apparatus according to claim 10, wherein the apparatus is further caused to send the assistance information to the control plane entity of the centralized unit in an E1AP DL Data Notification message.

13. An apparatus comprising at least one processing core and at least one memory storing instructions that, when executed by the at least one processing core, cause the apparatus, at least to:
receive assistance information from a radio access node, for an ongoing small data transmission; (SDT), procedure with a user equipment, (UE), wherein the apparatus is a control plane entity of a centralized unit for a base station, the base station comprising the centralized unit and a distributed unit, and
determine, based at least in part on the received assistance information, whether to switch the radio resource control, (RRC), state of the UE.

14. The apparatus according to claim 13, wherein the apparatus is further caused to:
determine, based on the assistance information, to switch the UE to RRC connected state, and
send an RRC message to switch the UE to the RRC connected state.

15. The apparatus according to claim 13, wherein the assistance information comprises at least one of:
an indication of data volume,
a UE buffer status report,
an indication that a data volume has exceeded at least one data volume threshold,
an indication of a value of a timer related to the SDT procedure,
an indication that the timer has less than a threshold duration remaining,
a recommendation or preference of switching the radio resource control state of the UE,
a recommendation or preference of the radio resource control state of the UE.

16. The apparatus according to claim 13, wherein the apparatus is further caused to:
signal to the radio access node at least one of at least one data volume threshold value or an initial SDT timer value,
receive the assistance information from the radio access node as a response to the signalling.

17. The apparatus according to claim 13, wherein the radio access node is the distributed unit, or comprised in the distributed unit, and wherein the apparatus is further caused to receive the assistance information in an F1AP UE Context Modification Required message or an E1AP DL Data Notification message.

18. (canceled)

19. The apparatus according to claim 13, wherein the radio access node is a user plane entity of the central unit of the base station.

20. The apparatus according to claim 15, wherein the apparatus is further caused to perform the determining whether to switch the RRC state of the UE based at least in part on determining that a quantity of data to be transmitted, determined based on the buffer status report, exceeds the at least one data volume threshold.

21. The apparatus according to claim 16, wherein the apparatus is further caused to perform the signalling of the at least one of the at least one data volume threshold or the initial SDT timer value in an F1AP UE Context Setup Request message or an F1AP UE Context Modification Request message or an E1AP Bearer Context Setup Request message or an E1AP Bearer Context Modification Request message.

22-27. (canceled)
